(19) United States
(12) Patent Application Publication
(10) Pub. No.: US 2026/0365110 A1
(43) Pub. Date: Nov. 19, 2026

(54) VEHICULAR VISION SYSTEM WITH ENHANCED COMMUNICATION BETWEEN CAMERA AND REMOTE ECU

(71) Applicant: Magna Electronics Inc., Auburn Hills, MI (US)

(72) Inventor: Patrick A. Miller, Saginaw, MI (US)

(21) Appl. No.: 19/671,499

(22) Filed: May 8, 2026

Related U.S. Application Data
(60) Provisional application No. 63/805,417, filed on May 14, 2025.

(51) Int. Cl. B60R 1/26; B60R 1/04; B60R 1/27

(52) U.S. Cl. CPC B60R 1/26; B60R 1/04; B60R 1/27; B60R 2300/408; B60R 2300/607

(57) ABSTRACT

A vehicular vision system includes a camera and an electronic control unit (ECU) remote from the camera. The camera includes an electrical component with a single general purpose input/output (GPIO) pin. The ECU is in communication with the electrical component. The single GPIO pin is electrically connected to a first input of the imager via a first signal path. The single GPIO pin is electrically connected to a second input of the imager via a second signal path, and wherein the second signal path comprises a low-pass filter. The ECU is configured to transmit a combined control signal to the electrical component. The electrical component is configured to output the combined control signal at the single GPIO pin. The low-pass filter is configured to attenuate a first control signal and pass a second control signal to the second input of the imager.

### CROSS REFERENCE TO RELATED APPLICATION

The present application claims the filing benefits of U.S. provisional application Ser. No. 63/805,417, filed May 14, 2025, which is hereby incorporated herein by reference in its entirety.

### TECHNICAL FIELD

The present disclosure relates generally to a vehicle vision system for a vehicle and, more particularly, to a vehicle vision system that utilizes one or more cameras at a vehicle.

### BACKGROUND

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY

A vehicular vision system includes a camera disposed at a vehicle equipped with the vehicular vision system and viewing exterior of the vehicle. The camera is operable to capture image data. The camera includes an imager. The system includes an electronic control unit (ECU) with electronic circuitry and associated software, and the ECU is disposed at the vehicle remote from the camera. The electronic circuitry of the ECU includes an image processor for processing image data captured by the camera. The camera includes an electrical component with a single general purpose input/output (GPIO) pin, and the ECU is in communication with the electrical component. The single GPIO pin is electrically connected to a first input of the imager via a first signal path. The single GPIO pin is electrically connected to a second input of the imager via a second signal path, and the second signal path includes a low-pass filter. The ECU is configured to transmit a combined control signal to the electrical component, and the combined control signal includes a first control signal having a first frequency and a second control signal having a second frequency lower than the first frequency. The electrical component is configured to output the combined control signal at the single GPIO pin. The low-pass filter is configured to attenuate the first control signal and pass the second control signal to the second input of the imager.

These and other objects, advantages, purposes and features of the present disclosure will become apparent upon review of the following specification in conjunction with the drawings.

### BRIEF DESCRIPTION OF THE DRAWINGS

FIG. 1 is a plan view of a vehicle with a vision system that incorporates cameras;

FIG. 2 is a schematic view of a camera with a general purpose input/output (GPIO) expander;

FIG. 3 is a schematic view of a camera with combined GPIO signals; and

FIG. 4 is a plot of the combined GPIO signals of FIG. 3.

### DETAILED DESCRIPTION

A vehicle vision system and/or driver or driving assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. Such systems may form part of a comprehensive Advanced Driver Assistance System (ADAS) or an autonomous driving framework, providing safety and convenience functions such as lane departure warning, automatic emergency braking, cross-traffic alert, pedestrian detection, blind-spot monitoring, and automated parking assistance. The vision system includes an image processor or image processing system that is operable to receive image data from one or more cameras and provide an output to a display device for displaying images representative of the captured image data. Optionally, the vision system may provide a display, such as a rearview display or a top down or bird's eye or surround view display or the like. These displays may utilize sophisticated image stitching techniques to seamlessly combine video feeds from multiple peripheral cameras, providing a comprehensive 360-degree environmental awareness for the driver, even in challenging environmental conditions such as low light, rain, or snow.

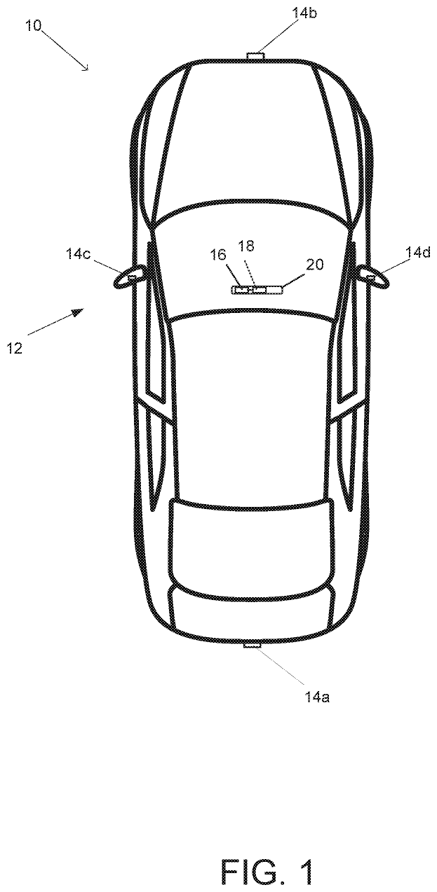

Referring now to the drawings and the illustrative embodiments depicted therein, a vehicle 10 includes an imaging system or vision system 12 that includes at least one exterior-viewing imaging sensor or camera, such as a rear backup camera or rearward-viewing imaging sensor or camera 14a (and the system may optionally include multiple exterior-viewing imaging sensors or cameras, such as a forward-viewing camera 14b at the front (or at the windshield) of the vehicle, and a sideward/rearward-viewing camera 14c, 14d at respective sides of the vehicle), which captures images exterior of the vehicle, with the camera having a lens for focusing images at or onto an imaging array or imaging plane or imager of the camera (FIG. 1). The cameras 14a-14d may utilize various types of optics, such as wide-angle or fisheye lenses, and may be integrated into various structural locations across the vehicle, such as within a front grille, a rear liftgate or decklid, exterior side mirrors, or roof-mounted modules (e.g., a shark-fin antenna).

Optionally, a forward-viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 having electronic circuitry and associated software, with the electronic circuitry including a data processor or image processor that is operable to process image data captured by the camera or cameras, whereby the ECU may detect or determine presence of objects or the like and/or the system provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle).

To execute these features, the ECU 18 may leverage machine learning algorithms, neural networks, or other advanced computer vision techniques to rapidly classify and track detected objects. The data transfer or signal communication from the camera to the ECU may comprise any suitable data or communication link, such as a vehicle network bus or the like of the equipped vehicle. This data transfer may be facilitated over physical media such as coaxial cables or shielded twisted pair (STP) cables, utilizing high-bandwidth networked protocols including, for example, Automotive Ethernet, Controller Area Network (CAN), or flexible data-rate CAN (CAN-FD).

In some vehicular cameras, particularly “dumb” or satellite cameras that do not incorporate a dedicated microcontroller, a remote ECU may control the camera (and may include an image processor that processes image data captured by the camera and transferred to the ECU). These satellite cameras are often preferred for automotive applications because omitting the microcontroller and heavy image processing hardware from the camera head significantly reduces the physical footprint, weight, bill of materials (BOM) cost, and thermal dissipation of the camera module, thereby allowing for tighter and more flexible aesthetic integration into the vehicle's exterior. That is, the ECU that controls the camera is located elsewhere in the vehicle remote from the camera, and may be connected to the camera via a cable, such as a coaxial cable or the like. This control may be effectuated at least partially through the multiple general purpose input/output (GPIO) signals transmitted across a high-speed serial link.

This high-speed serial link typically employs a Serializer/Deserializer (SerDes) architecture (such as FPD-Link, GMSL, or APIX standards) to transmit high-definition video data forward to the ECU while simultaneously maintaining a lower-speed, bidirectional back-channel for camera control and configuration. In this scenario, a serializer is often present at the camera and a deserializer is present at the ECU, or vice-versa. A challenge in such systems is the limited number of GPIOs available on the serializer or deserializer. Due to strict constraints on integrated circuit (IC) package size and pin counts—driven by the need to keep the camera printed circuit board (PCB) as small as possible—the number of available GPIOs is frequently insufficient to support all desired features and/or customer requirements. These requirements may include, but are not limited to, hardware reset signaling, frame synchronization, power mode toggling, or operating peripheral components like lens heaters, LED indicators, and automated lens cleaning mechanisms.

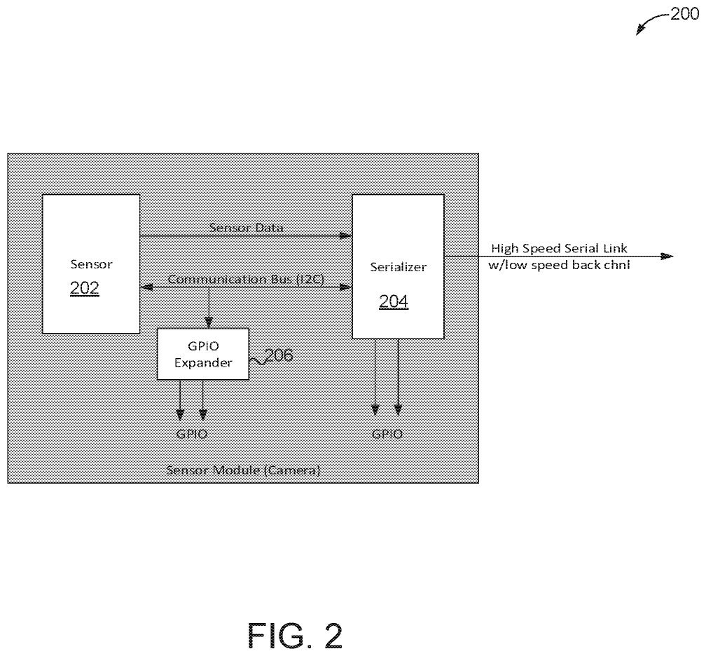

Referring to FIG. 2, a block diagram 200 illustrates an approach to address the limitation of available GPIOs. In this example, a camera includes a sensor 202 in communication with an electrical component, such as a serializer 204, via a communication bus, such as an Inter-Integrated Circuit (I2C) bus. The serializer 204 (or other component) may provide a limited number of its own GPIOs. To supplement these, a GPIO expander 206 is coupled to the I2C bus. The GPIO expander 206 provides additional GPIOs that may be controlled by the remote ECU via commands sent over the I2C bus, which itself may be tunneled over the high-speed serial link via the SerDes back-channel. While functional and capable of enabling the necessary register reads/writes for component control, the inclusion of the GPIO expander 206 adds to the overall cost and physical size of the camera system. Deploying a dedicated GPIO expander IC occupies valuable real estate on a highly constrained camera PCB, complicates the routing of electrical traces, increases power consumption, and introduces additional potential points of failure within the camera's hardware architecture.

Implementations herein are directed toward increasing the effective number of GPIO signals without requiring a dedicated GPIO expander device, thereby reducing cost and size while maintaining comprehensive control over the camera module's features. In some implementations, this is achieved by combining multiple signals, typically a high-frequency or timing-critical signal with one or more lower-frequency or non-timing-critical signals, onto a single GPIO line. By utilizing the different frequency domains of these signals, frequency division multiplexing principles can be practically applied directly onto a baseband GPIO trace. Separation of these combined signals may then be performed at the receiving end on the camera hardware using filtering techniques. Consequently, a single hardware pin on the serializer can effectively drive two or more distinct operational parameters. This signal combination successfully recovers valuable GPIO resources, circumvents the necessity for a secondary expander IC, and ultimately enables a more compact, robust, and cost-effective vehicular camera design.

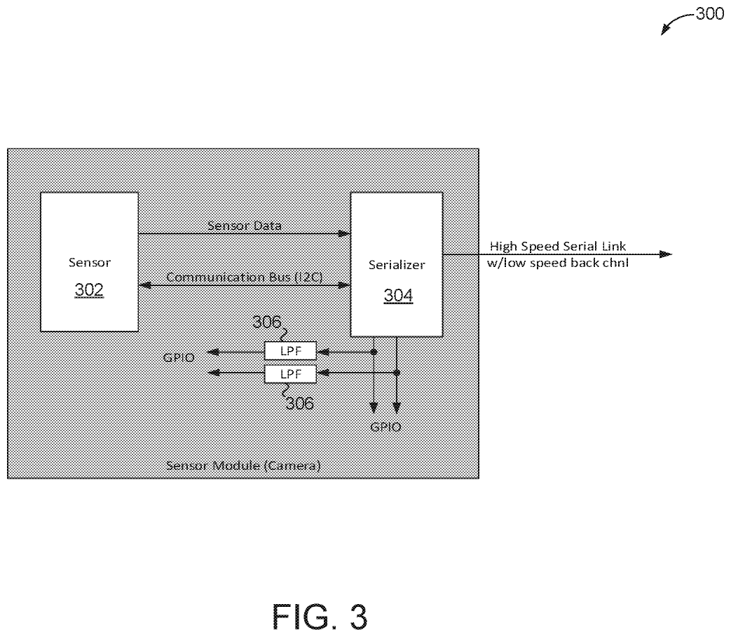

Referring now to FIG. 3, a block diagram 300 illustrates a camera that includes a sensor 302 (or any other component of the camera, such as an imager, an image signal processor (ISP), a power management integrated circuit (PMIC), or environmental sensors) in communication with a serializer 304. The serializer 304 provides a set of GPIO connections, which act as hardware interfaces to drive local peripheral logic. Instead of a GPIO expander (FIG. 2), here one or more of the available GPIO lines from the serializer 304 are utilized to carry multiple control signals simultaneously. By multiplexing signals in the frequency domain at the remote ECU, the receiving serializer 304 outputs a single waveform on a specific GPIO pin that contains multiple distinct operational directives for the sensor 302.

The GPIOs from the serializer 304 may receive a combined signal. This combined signal may be composed of a high-frequency signal (e.g., an AC or rapidly transitioning digital waveform) and a low-frequency signal (e.g., a DC, quasi-DC, or slowly transitioning logic state). To decouple these commands on the camera's printed circuit board (PCB), a low-pass filter 306, which may include, for example, a resistor and a capacitor (such as an RC network having a predefined time constant), is coupled to one or more of the GPIOs from the serializer 304. The low-pass filter 306 is configured to substantially pass the low-frequency signal to an input of the sensor 302 (or other component of the camera) while substantially attenuating, blocking, or integrating the high-frequency signal. Conversely, the high-frequency signal may be tapped off the GPIO line at a node located electrically before the low-pass filter 306 and provided to a different input of the sensor 302 or another component that requires the high-frequency signal. This high-frequency tap may be routed as a direct, unattenuated copper trace to ensure signal integrity and minimal propagation delay for timing-sensitive inputs.

The high-frequency signals may include, for example, signals such as frame synchronization signals (e.g., FSIN for triggering image capture at specific intervals, such as 30 Hz or 60 Hz), clock signals (e.g., system reference clocks), pulse-width modulated (PWM) signals (e.g., for LED dimming), or other timing-critical data possessing fast edge rates (i.e., fast rise and fall times). The low-frequency signals may include signals that are not as timing-critical, do not require high bandwidth (relative to the high-frequency signals), and typically represent sustained logic levels. Example low-frequency signals include mode selection signals, component enable/disable signals, sleep/standby mode toggles, or power reset signals. The low-pass filters 306 may include a passive filter implemented using discrete components for a cost-effective solution. Utilizing passive surface-mount devices (SMDs) such as resistors and capacitors allows the filtering topology to occupy minimal physical footprint on the PCB (e.g., using 0402 or 0201 package sizes), ensuring compliance with strict automotive packaging constraints while also maintaining high reliability across extreme temperature variations and electromagnetic interference (EMI) commonly encountered in vehicular environments.

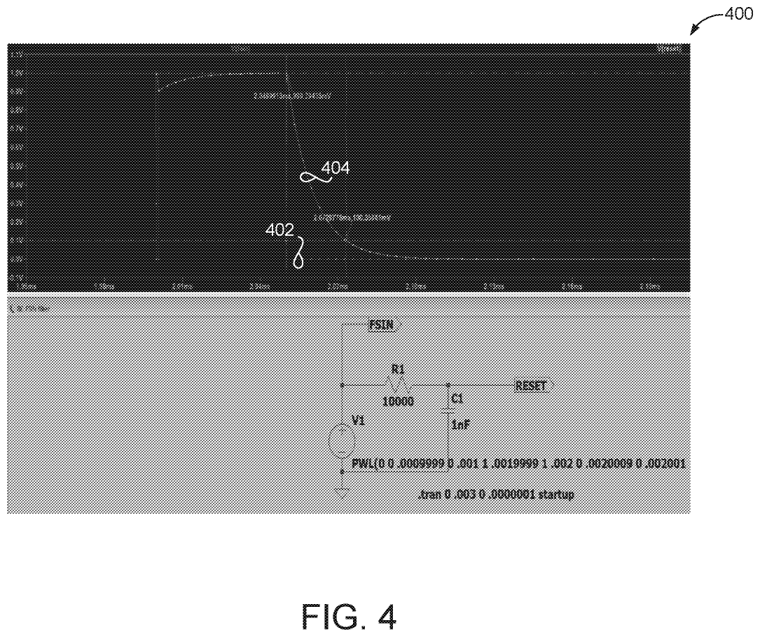

FIG. 4 illustrates a simulation diagram 400 illustrating the behavior of a combined signal and its subsequent separation at the hardware level. The simulation depicts a scenario where an imager frame sync signal (FSIN), which is a high-frequency signal consisting of periodic, narrow pulses, is combined with a camera reset signal (RESET), which is a low-frequency or quasi-DC signal used to initialize the camera hardware. The combined signal is transmitted over a single GPIO line from the serializer 304 to the respective inputs of the sensor 302. To achieve this without unintended triggering, the duty cycle and amplitude of the high-frequency FSIN pulses are strategically configured such that, when integrated by the low-pass filter 306, the resulting average DC voltage delivered to the reset input remains safely isolated from the logic transition thresholds (e.g., V_IH or V_IL) required to trigger a change of state.

In FIG. 4, the y-axis represents voltage and the x-axis represents time. The trace 402 represents the FSIN signal as received on a GPIO of the camera's serializer from a remote ECU. This FSIN 402 retains the characteristics of a high-bandwidth digital signal with fast edge rates, ensuring precise and reliable frame synchronization for image capture. The trace 404 represents the RESET signal after being processed by a low-pass filter, such as the RC filter of FIG. 4 (which comprises a resistor R1 and a capacitor C1). In this example, when a pulse occurs on FSIN 402, the pulse would typically be passed through as a timing signal to an imager via the unattenuated tap. During such a pulse, RESET 404, being highly filtered by the time constant (τ) of the RC network, exhibits at most a slight transient voltage fluctuation (as depicted by the minor rise in trace 404 corresponding to the pulse of trace 402).

This fluctuation is engineered to remain within the noise margin of the receiving component. Because the peak voltage of this fluctuation is strictly controlled and is therefore insufficient to cross the required logic transition threshold (e.g., standard CMOS input thresholds such as V_IH or V_IL) to cause a digital transition of state for the RESET signal, the system thereby effectively avoids an unintended reset of the hardware. As another example, when it is desired to intentionally actuate the control signal, the ECU alters the base waveform. When FSIN 402 is held in a low state for an extended duration (e.g., a duration significantly longer than the time constant of the low-pass filter), RESET 404 slowly transitions to a low state. That is, the low-frequency component (i.e., RESET 404) follows the sustained state of the input signal after filtering, eventually crossing the logic threshold to actuate the reset or alternative command. In some implementations, when components such as an imager or an image signal processor (ISP) have stringent requirements for maximum rise/fall times of input signals, additional circuitry may be incorporated. Because a heavily filtered signal inherently possesses a slow transition rate or slew rate, the intermediate voltage levels generated during this slow transition could potentially cause metastable states, signal bounce, or excessive current draw in standard digital inputs. To prevent this, such circuitry, for example, a Schmitt trigger or buffer featuring electrical hysteresis, may be used to sharpen the edges of the extracted low-frequency signal (e.g., the RESET signal), thereby snapping the slow-moving analog curve into a crisp, immediate digital step once the designated threshold is breached.

Thus, implementations herein include combining signals with different frequency characteristics onto a single GPIO line and then separating the signals using passive low-pass filters, which allows for an increased utilization of available GPIOs. By successfully multiplexing a dynamic, high-frequency timing signal with a static or quasi-static control signal on a single physical pin, the system architecture is highly optimized. This approach may lead to a substantial reduction in size and/or cost by eliminating the need for a dedicated GPIO expander and its associated passive components. Consequently, this shrinks the required printed circuit board (PCB) footprint, lowers the overall Bill of Materials (BOM) cost, simplifies routing requirements, and improves total system reliability by reducing the number of integrated circuits and solder joints susceptible to mechanical failure in high-vibration vehicular environments.

While examples herein primarily discuss a camera, it should be appreciated that other sensors/components may benefit from the combined GPIO signals (e.g., radar sensors, LIDAR, displays, ultrasonic sensors, etc.). For instance, in a vehicular LIDAR or radar system, a high-frequency synchronization signal used for laser firing intervals or radar chirp timing could be seamlessly combined with a low-frequency sensor configuration or sleep-mode signal using the identical filtering topology described herein.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in U.S. Pat. No. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two-dimensional array of a plurality of photosensor elements arranged in at least 640 columns and 480 rows (at least a 640×480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels arranged in rows and columns. The imaging array may be sensitive to near-infrared light. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014-0347486; US-2014-0320658; US-2014-0336876; US-2014-0307095; US-2014-0327774; US-2014-0327772; US-2014-0320636; US-2014-0293057; US-2014-0309884; US-2014-0226012; US-2014-0293042; US-2014-0218535; US-2014-0218535; US-2014-0247354; US-2014-0247355; US-2014-0247352; US-2014-0232869; US-2014-0211009; US-2014-0160276; US-2014-0168437; US-2014-0168415; US-2014-0160291; US-2014-0152825; US-2014-0139676; US-2014-0138140; US-2014-0104426; US-2014-0098229; US-2014-0085472; US-2014-0067206; US-2014-0049646; US-2014-0052340; US-2014-0025240; US-2014-0028852; US-2014-005907; US-2013-0314503; US-2013-0298866; US-2013-0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The camera may be electrically connected to the ECU via a cable, such as a coaxial cable that provides bi-directional communication between the camera and the ECU. For example, the coaxial cable may provide power from the ECU to the camera and may provide control signals or data to the camera, and may receive image data from the camera. The coaxial cable and electronic connection between the ECU and the camera may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the camera from the camera to the ECU, (ii) control signals from the ECU to the camera, and (iii) electrical power from a DC power supply of (or connected to) the ECU to the camera.

Changes and modifications in the specifically described embodiments can be carried out without departing from the principles of the disclosure, which is intended to be limited only by the scope of the appended claims, as interpreted according to the principles of patent law including the doctrine of equivalents.

1. A vehicular vision system comprising:
a camera disposed at a vehicle equipped with the vehicular vision system and viewing exterior of the vehicle, wherein the camera is operable to capture image data;
wherein the camera comprises an imager;
an electronic control unit (ECU) comprising electronic circuitry and associated software, and wherein the ECU is disposed at the vehicle remote from the camera;
wherein the electronic circuitry of the ECU comprises an image processor for processing image data captured by the camera;
wherein the camera comprises an electrical component comprising a single general purpose input/output (GPIO) pin, and wherein the ECU is in communication with the electrical component;
wherein the single GPIO pin is electrically connected to a first input of the imager via a first signal path;
wherein the single GPIO pin is electrically connected to a second input of the imager via a second signal path, and wherein the second signal path comprises a low-pass filter;
wherein the ECU is configured to transmit a combined control signal to the electrical component, and wherein the combined control signal comprises a first control signal having a first frequency and a second control signal having a second frequency lower than the first frequency; and
wherein the electrical component is configured to output the combined control signal at the single GPIO pin, wherein the low-pass filter is configured to attenuate the first control signal and pass the second control signal to the second input of the imager.

2. The vehicular vision system of claim 1, wherein the electrical component is a serializer.

3. The vehicular vision system of claim 1, wherein the first control signal comprises a frame synchronization signal.

4. The vehicular vision system of claim 1, wherein the second control signal comprises a reset command.

5. The vehicular vision system of claim 1, wherein the low-pass filter comprises at least one resistor and at least one capacitor.

6. The vehicular vision system of claim 1, wherein the first signal path comprises an unattenuated electrical connection between the single GPIO pin and the first input of the imager.

7. The vehicular vision system of claim 1, wherein the camera further comprises a Schmitt trigger disposed along the second signal path electrically between the low-pass filter and the second input of the imager.

8. The vehicular vision system of claim 1, wherein the camera and the ECU are connected via a coaxial cable, and wherein the ECU is configured to transmit data to the electrical component over a serialized back-channel of the coaxial cable.

9. The vehicular vision system of claim 1, wherein the ECU is configured to actuate the second control signal at the second input of the imager by holding the combined control signal in a sustained logic state for a duration that exceeds a time constant of the low-pass filter.

10. The vehicular vision system of claim 1, wherein the camera is a satellite camera without a dedicated microcontroller.

11. A method for operating a vehicular vision system, the method comprising:
providing a camera disposed at a vehicle and viewing an exterior of the vehicle, the camera comprising an imager and an electrical component, wherein the electrical component comprises a single general purpose input/output (GPIO) pin, wherein the single GPIO pin is electrically connected to a first input of the imager via a first signal path, and wherein the single GPIO pin is electrically connected to a second input of the imager via a second signal path comprising a low-pass filter;
capturing image data at the exterior of the vehicle via the imager;
processing the captured image data via an electronic control unit (ECU) disposed at the vehicle remote from the camera;
transmitting, via the ECU, a combined control signal to the electrical component, wherein the combined control signal comprises a first control signal having a first frequency and a second control signal having a second frequency lower than the first frequency;
outputting, via the electrical component, the combined control signal at the single GPIO pin;
passing the first control signal to the first input of the imager via the first signal path; and
attenuating, via the low-pass filter, the first control signal and passing the second control signal to the second input of the imager via the second signal path.

12. The method of claim 11, wherein the electrical component is a serializer.

13. The method of claim 11, wherein the first control signal comprises a frame synchronization signal.

14. The method of claim 11, wherein the second control signal comprises a reset command.

15. The method of claim 11, wherein the low-pass filter comprises at least one resistor and at least one capacitor.

16. The method of claim 11, wherein passing the first control signal to the first input of the imager via the first signal path comprises passing the first control signal over an unattenuated electrical connection between the single GPIO pin and the first input of the imager.

17. The method of claim 11, wherein the camera further comprises a Schmitt trigger disposed along the second signal path electrically between the low-pass filter and the second input of the imager, the method further comprising sharpening edges of the passed second control signal via the Schmitt trigger prior to the second control signal reaching the second input of the imager.

18. The method of claim 11, wherein the camera and the ECU are connected via a coaxial cable, and wherein transmitting the combined control signal to the electrical component comprises transmitting data over a serialized back-channel of the coaxial cable.

19. The method of claim 11, further comprising actuating the second control signal at the second input of the imager by holding, via the ECU, the combined control signal in a sustained logic state for a duration that exceeds a time constant of the low-pass filter.

20. The method of claim 11, wherein the camera is a satellite camera without a dedicated microcontroller.
